(19) United States
(12) Patent Application Publication
(10) Pub. No.: US 2002/0156818 A1
(43) Pub. Date: Oct. 24, 2002

(54) Microprocessor comprising an instruction for inverting bits in a binary word

(75) Inventors: Franck Roche, Trets (FR); Nicolas Lafargue, Montbonnot (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.A., Montrouge (FR)

(21) Appl. No.: 10/068,568

(22) Filed: Feb. 6, 2002

(30) Foreign Application Priority Data
Feb. 8, 2001 (FR) 0101681

(51) Int. Cl. G06F 7/00

(52) U.S. Cl. 708/200

(57) ABSTRACT

A microprocessor comprises a central processing unit having an arithmetic and logic unit with two inputs and one input fed-back to one of the inputs through a data path. The arithmetic and logic unit performs arithmetic and logic operations on binary words temporarily stored within registers in the central processing unit. The central processing unit further includes a shift unit in the data path of the arithmetic and logic unit for performing operations to shift bits in the binary words applied thereto. A selection circuit selects a shift operation to be performed. An inverting circuit inverts the ordering of the bits in the binary words applied thereto, which are in the data path of the arithmetic and logic unit, and a selection circuit selects the inversion operation when the latter is required.

### FIELD OF THE INVENTION

The present invention relates to integrated circuits, and more particularly, to a microprocessor for managing peripheral equipment.

### BACKGROUND OF THE INVENTION

Peripheral equipment is generally connected to a microprocessor through parallel or serial input/output ports. However, it often happens that the ordering of bits in the words exchanged with such peripheral equipment is inverted, as seen from either the equipment side or the microprocessor side. This means, for example, that for a word with eight bits from 0 to 7, bit 0 is transmitted instead of bit 7, bit 6 instead of bit 1, and so on. For the microprocessor to be able to communicate properly with the peripheral equipment, it has to invert the bits in the binary words exchanged with the peripheral equipment.

This bit inversion operation on the binary words proves to be relatively costly in the number of required instructions, and therefore processing time. This can result in substantial problems when the peripheral equipment has to be controlled in real time while complying with very short delays.

### SUMMARY OF THE INVENTION

In view of the foregoing background, an object of the present invention is to eliminate the above described drawbacks, based on the fact that most microprocessors, even those with a simplified architecture, have instructions for manipulating bits in binary words, such as instructions for shifting or swapping the most significant portion of the word with the least significant one.

This and other objects, advantages and features of the present invention are achieved by a microprocessor comprising a central processing unit including an arithmetic and logic unit having at least two inputs and one output which is fed-back to one of the inputs through a data path. The arithmetic and logic unit includes means for performing arithmetic and logic operations on binary words that are temporarily stored within registers in the central processing unit.

The central processing unit further comprises a shift unit interposed in the data path of the arithmetic and logic unit, and means for performing bit shifting operations in binary words supplied thereto. Selection means is also provided for selecting a shift operation to be performed. The microprocessor further comprises inverting means for inverting the ordering of bits in the binary words which are supplied thereto, with the means being interposed in the data path of the arithmetic and logic unit. Selection means selects the inversion operation when the latter is required.

Advantageously, the inverting means may be integrated within the shift unit. Preferably, the shift unit may be arranged upstream one of the arithmetic and logic unit inputs. Alternatively, the shift unit may be arranged at the output of the arithmetic and logic unit.

According to one aspect of the invention, the shift unit comprises as many demultiplexers as there are bits in the words to be processed. Each demultiplexer has a binary input and as many binary outputs as there are shift operations to be performed. The outputs of the demultiplexers are each connected to one line of a bus connected to the output of the shift unit, and there are at least as many lines as there are bits in the words to be processed.

The demultiplexers receive as an input one respective bit of the word being applied as an input to the shift unit, and outputs the value of the input bit at one of the demultiplexer's outputs. This output is selected in accordance with the shift operation to be performed. The line of the bus to which each output of each demultiplexer is connected is chosen in accordance with the rank, within the word to be processed, of the bit input to the demultiplexer and with the shift operation corresponding to the demultiplexer output.

According to another embodiment of the invention, the inverting means for inverting the ordering of bits in binary words may be arranged upstream the shift unit.

### BRIEF DESCRIPTION OF THE DRAWINGS

These and other objects, features and advantages of the present invention will become more apparent upon a consideration of the following detailed description of a microprocessor taken in a non-limiting way in conjunction with the accompanying drawings, in which:

FIG. 1 is a simplified schematic diagram on the structure of a microprocessor modified according to the invention;

FIG. 2 is a detailed schematic diagram of a portion of the microprocessor's processing unit modified according to the invention; and

FIG. 3 is a schematic diagram showing a modification to the microprocessor illustrated in FIG.

### DETAILED DESCRIPTION OF THE PREFERRED EMBODIMENTS

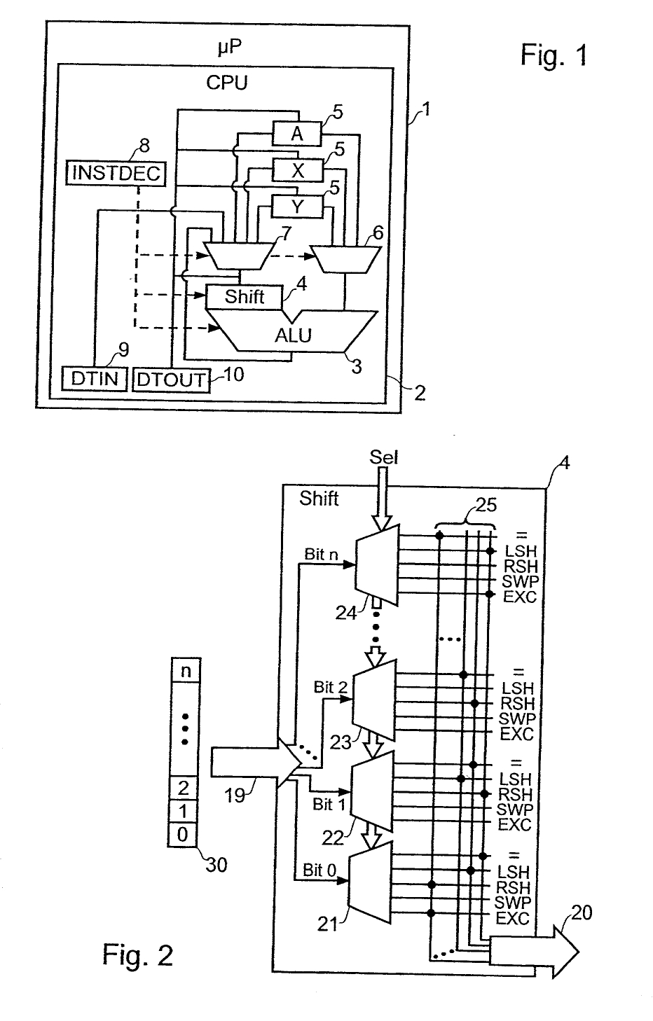

FIG. 1 shows a microprocessor 1 comprising a central processing unit (CPU) 2. The central processing unit 2 comprises, in particular, registers 5 for temporarily storing binary words that are manipulated by the microprocessor and which are fed with various microprocessor executable instructions. An arithmetic and logic unit (ALU) 3 has two inputs and one output, and is designed for executing the logic and arithmetic instructions on the binary words stored within the registers 5. Two multiplexers 6, 7 have their inputs connected to the registers 5 and their respective outputs to the two ALU inputs. This is for selecting two of the registers to be respectively applied to both of these inputs.

The multiplexer 7 further comprises two other inputs, one of which is connected to the ALU output and the other to the data input register DTIN 10 of the central processing unit 2. Arithmetic and logic unit 3 comprises two inputs for simultaneously receiving two binary words when a two-operand operation is to be executed.

Some microprocessors, such as the one shown in FIG. 1, further comprise a shift unit 4 interposed in the data path of the ALU 3, i.e., between the ALU output and one of its two inputs. This unit is designed for rearranging the bits in the binary words input to the ALU in a different order. In FIG. 1, the shift unit 4 is arranged at one of the two ALU inputs. Of course, it can also be arranged at another location in the data path of ALU 3, for example, at the ALU output.

In addition, the output of multiplexer 7 is fed-back to the registers 5 and is connected to a data output register DTOUT 10 of the central processing unit 2. Moreover, the central processing unit 2 comprises, in a conventional way, an instruction decoding unit 8 for controlling the ALU 3, the multiplexers 6 and 7, and the shift unit 4 in accordance with the instructions executed by the microprocessor 1.

FIG. 2 shows a detailed view of an exemplary embodiment of the shift unit. In this figure, the shift unit 4 comprises several mutliplexers 21 to 24, with one multiplexer per bit in the words 30 to be processed. Each demultiplexer receives as an input the value of a respective bit in the word input to the shift unit 4, and comprises one output per shift operation to be performed.

The respective demultiplexer outputs are connected to the output 20 of the shift unit 4 through a parallel bus 25 including as many lines as there are bits in the words to be processed 30. The connection between the output of each demultiplexer and the lines of the bus 25, is implemented in accordance with the rank of the bit input to the demultiplexer and with the shift operation corresponding to the demultiplexer's output.

The first shift operation “=” is performed by the first outputs of the demultiplexers 21 to 24, which supply the binary word bing applied as an input 19. The second and third shift operations “LSH” and “RSH” respectively provide, on the second and third outputs of the demultiplexers 21 to 24, a binary word corresponding to the input binary word 30 after it has been subjected to a one-bit shift left or right, respectively. Thus, these operations transfer the most significant bit n of the input word 30 to bits 0 and n−1 of the output word, respectively, bit k of the input word to bits k+1 and k−1 of the output word (0<k<n), respectively, and bit 0 of the input word to bits 1 and n of the output word, respectively.

The fourth shift operation 24 provides, on the fourth respective outputs of the demultiplexers 21 to 24, an output binary word corresponding to input word 30, wherein the most significant (bits n to

$$\frac{n + 1}{2}$$

for an (n+1)-bit word, where n+1 is even) and least significant (bits

$$\frac{n - 1}{2}$$

to 0) portions have been swapped.

According to the invention, the shift unit 4 has a fifth shift operation “EXC” obtained by the fifth respective outputs of the demultiplexers 21 to 24, which supply a word corresponding to the input binary word 30 with its bit positions inverted. Accordingly, this operation transfers bit k of input (n+1)-bit word 30 to bit n-k of the output word.

Of course, there are many other ways to implement the shift unit 4, and those skilled in the art will readily design a shift unit in other ways without departing from the scope of the invention as defined in the accompanying claims.

More specifically, the invention can be implemented by five wired shift circuits, with one circuit per shift operation to be performed. Each circuit is fed at its input with the binary word to be processed. One of the outputs of these wired circuits is selected to be transferred as an output of the shift unit 4 by a multiplexer having a selection control input for selecting a shift operation to be performed. Each shift circuit is simply implemented by lines appropriately interconnecting the input bits with the circuit output bits.

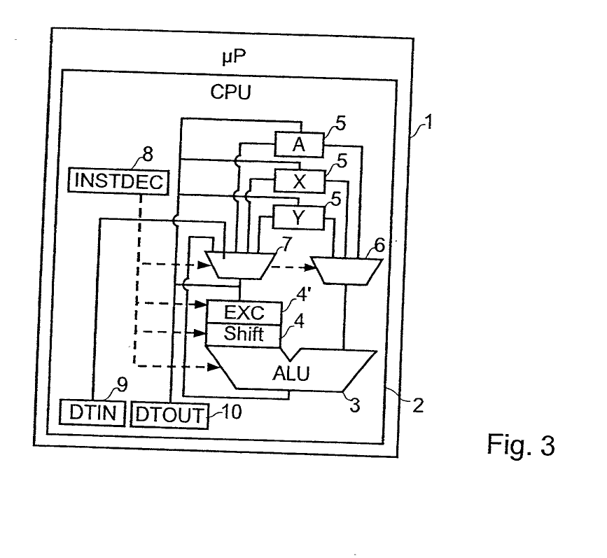

In the alternative embodiment of the microprocessor shown in FIG. 3, the conventional shift unit 4 remains unchanged. To carry out the bit inversion function, an additional circuit 4′ has been added in the data path of the ALU 3. This circuit is designed for performing the bit inversion function when the instruction decoder encounters such a command within the executed instructions. Such a circuit 4′ can be implemented simply as a wired circuit in which the inputs for bits k of the word to be processed are either connected to the outputs of bits k (without ordering change) in the case when the inversion function is not required, or to the outputs of bits n-k (where n+1 is the bit number of the words to be processed) in the opposite case.

Shift unit 4 can further be implemented by n+1 multiplexers, where n+1 is the bit number of the binary word 30 to be processed. Each multiplexer receives as an input all the binary word bits input to the shift unit 4. The respective outputs of the multiplexers respectively provide the output word bits. The multiplexers are selectively controlled to perform the above mentioned transformation operations, for example, by loading a register with an (n+1)-bit command word.

Each bit is applied to selectively control a respective mutiplexer. The command word can be obtained from a table corresponding to the transformation operation to be performed. This structure allows other transformation operations to be performed. For this purpose, it is sufficient to provide a corresponding command word in the table.

That which is claimed is:

1. A microprocessor comprising a central processing unit (2) having an arithmetic and logic unit (3) with at least two inputs and one input which is fed-back to one of said inputs through data paths, the arithmetic and logic unit (3) including means for performing arithmetic and logic operations on the binary words temporarily stored within registers (5) in the central processing unit (2), the central processing unit further comprising a shift unit (4) interposed in the data path of the arithmetic and logic unit (3), and comprising means for performing shift operations on the bits of the binary words that are supplied thereto, and selection means for selecting a shift operation to be performed,
characterized in that it further comprises inverting means (4, 4′) for inverting the ordering of bits of binary words that applied thereto, which means are interposed in the data path of the arithmetic unit, and selection means for selecting the inversion operation when the latter is required.

2. The microprocessor according to claim 1, characterized in that the inverting means (4) are integrated within the shift unit (4).

3. The microprocessor according to claim 2, characterized in that the shift unit (4) is arranged upstream one of the inputs of the arithmetic and logic unit (3).

4. The microprocessor according to claim 2, characterized in that the shift unit (4) is arranged at the output of the arithmetic and logic unit (3).

5. The microprocessor according to any of claims 1 to 4, characterized in that the shift unit comprises as many demultiplexers (21 to 24) as there are bits in the words to be processed (30), each demultiplexer having a binary input and as many binary outputs as there are shift operations to be performed, the outputs of the demultiplexers each being connected to one line of a bus (25) connected to the output (20) of the shift unit and having at least as many lines as there are bits in the words to be processed, the demultiplexers (21 to 24) receiving as an input one respective bit of the word applied as an input (19) to the shift unit (4), and outputting the value of the bit input at one of the demultiplexer's outputs, which is selected as a function of the shift operation to be performed, the line of the bus (25) to which each output of each demultiplexer is connected being chosen in accordance with the rank, within the word to be processed, of the bit input to the demultiplexer and with the shift operation corresponding to the demultiplexer output.

6. The microprocessor according to any of claims 1 to 5, characterized in that the inverting means (4′) for inverting the ordering of bits in binary words are arranged upstream the shift unit (4).
